(19) United States
(12) Patent Application Publication
(10) Pub. No.: US 2005/0154646 A1
(43) Pub. Date: Jul. 14, 2005

(54) Method and system for self-service shopping

(76) Inventor: John Chermesino, Orangevale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/756,632

(22) Filed: Jan. 12, 2004

(51) Int. Cl. G06F 17/60

(52) U.S. Cl. 705/26

(57) ABSTRACT

Methods and systems for self-service shopping are described. A user profile is received at a mobile personal identifier. In addition, an item description is received at one of a plurality of second computing systems located throughout a shopping environment. The user profile is received at the second computing systems from the mobile personal identifier. A transaction is performed utilizing the user profile and the item description at one of the second computing systems, wherein the transaction is a self-service shopping transaction.

### TECHNICAL FIELD

Embodiments of the present invention relate to retail purchase. More specifically, embodiments of the present invention relate to a self-service shopping environment.

### BACKGROUND ART

In today's marketplace, consumer convenience and timesavings are highly valued. For example, if two stores offer the same product at the same price, the store that is most convenient and time saving to the customer is the store that will retain the most customers. That is, if one store has long lines with few check-out lanes and the other store provides more check-out lanes and shorter lines (and therefore, faster service) more customers will be drawn to the “no waiting” store. In addition, in a large store, (e.g., a warehouse type establishment) in order to lower customer confusion and frustration, there are many “floor” employees whose role is to remain on the shop floor and be of help to a customer. For example, they may give directions to help a customer find a product.

However, even the most helpful of store policies require a plurality of paid workers to be “of assistance on the floor” or work behind the register. Therefore, in order to attract a customer by offering convenience and timesavings, an extra amount of money must be spent. This money expenditure is passed on to the customer in higher costs.

In addition, waiting in line at a checkout counter can be a long and. arduous process. Also, while waiting in line, any impulse purchases may be rethought or removed from the shopping basket completely. For example, if a customer walks past a bag of chips (or a hand tool, or television, etc.) and selects the bag of chips on a whim, a reexamination of the bag of chips at the checkout line may provide the customer ample opportunity to rethink the impulse buy, remember the diet, and take the bag of chips out of the basket. Therefore, although an initial impulse sale was initiated, the store lost out on the sale due to the length of idle time the customer spent in line waiting to check out.

One solution to the waiting-in-line-to-checkout process is the introduction of the self-checkout line. In general, a self-checkout line is similar in form and function to a regular checkout line except the cashier is replaced by the customer. For example, when a customer uses a self-checkout line, the customer pulls an item out of the basket and scans the item bar code for input into the cash register. After all the customer's items have been scanned, the cash register then totals the purchase. The customer then inputs the payment and receives a receipt.

However, the problem is that instead of the self-checkout line being a time saving convenience, it is a money saving issue for the shop that is an inconvenience and time-consuming affair for the average customer. That is, the only thing being saved is money for the retail establishment. The customer still waits in the checkout line, and still has time to rethink any impulse items in the shopping basket. In addition, when it is time to use the self-checkout apparatus, the average consumer (with little self-checkout experience) is much slower at the checkout process than a professional who spends days and weeks checking products.

Due to the recognized difficulties with current self-checkout systems, most self-checkout lines are manned by at least one employee who advises customers what to do and helps fix any errors or issues as they arise.

Accordingly, a more efficient way of progressing a customer through a shopping experience is desirable. Embodiments of the present invention provide such an improvement.

### DISCLOSURE OF THE INVENTION

Embodiments of the present invention pertain to methods and systems for self-service shopping are described. In one embodiment, a user profile is received at a mobile personal identifier. In addition, an item description is received at one of a plurality of second computing systems located throughout a shopping environment. The user profile is received at the second computing systems from the mobile personal identifier. A transaction is performed utilizing the user profile and the item description at one of the second computing systems, wherein the transaction is a self-service shopping transaction.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a system for self-service shopping check-in according to one embodiment of the present invention.

FIG. 2 illustrates a system for self-service scanning and purchase according to one embodiment of the present invention.

FIG. 3 is a diagram of an exemplary store configuration for self-service shopping according to one embodiment of the present invention.

FIG. 4 is a flowchart for self-service shopping according to one embodiment of the present invention.

FIG. 5 is a flowchart for self-service shopping according to another embodiment of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

In general, embodiments of the present invention allow customers to buy an item or items at several locations throughout a store without having to proceed to a central checkout line. In one embodiment, a customer logs in to a computing system prior to shopping and receives a mobile personal identifier. The system then recognizes the customer throughout the store. When the customer is ready to purchase an item, the customer scans an item at one of the plurality of scanning kiosks located throughout the store. Prior to, or during the scanning of the item, the scanning kiosk will also receive a transfer of data from the mobile personal identifier carried by the customer. The mobile personal identifier will provide the scanning kiosk with the appropriate data necessary to perform a purchase (e.g., payment information). In one embodiment, if the customer has a plurality of items to shop for and desires to defer payment until the shopping is complete, the system will also maintain an electronic shopping cart for the customer. When a customer completes the shopping and has scanned and accepted all items at any or all of the plurality of scanning kiosks, and completes the purchase, the customer then returns the mobile personal identifier and departs the store with goods in hand.

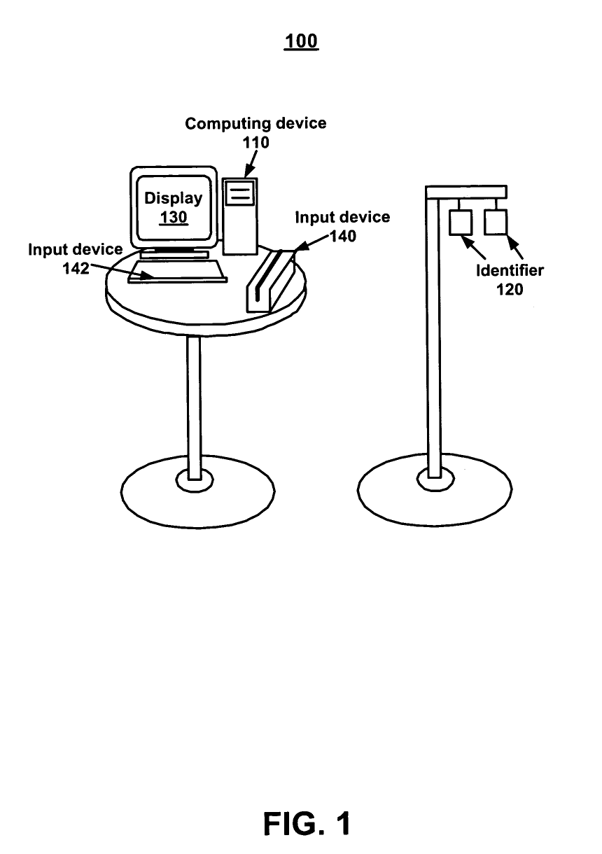

With reference now to FIG. 1, a network or system 100 for self-service shopping check-in is shown according to one embodiment of the present invention. It is appreciated that system 100 may include elements other than those shown. System 100 may also include more than one of the various elements shown. The functionality of each of these elements is discussed below; it is appreciated that these elements may implement functionality other than that discussed.

The self-service shopping check-in of FIG. 1 includes a computing device 110 and a mobile personal identifier 120. In one embodiment, computing device 110 is a computing system having a visual display 130 and a keyboard input device 142. In one embodiment, computing device 110 also has a card reader input device 140. Computing device 110 is any type of computing device which may be accessed by a user and which may receive input from an input device (e.g., a keyboard 142, card reader 140, touch screen 130, or the like) and output information to a display or vocally (if necessary). In one embodiment, computing device 110 is shown on a stand. The stand is optional and in other embodiments may not exist, may be a desk, may be a wall mount, may be a table, or the like. In one embodiment, computing device 110 is used as a database to store personal information including: shopping habits, payment methods, people in family, last shopping trip purchases, job, prior products looked at or scanned but not purchased, and the like.

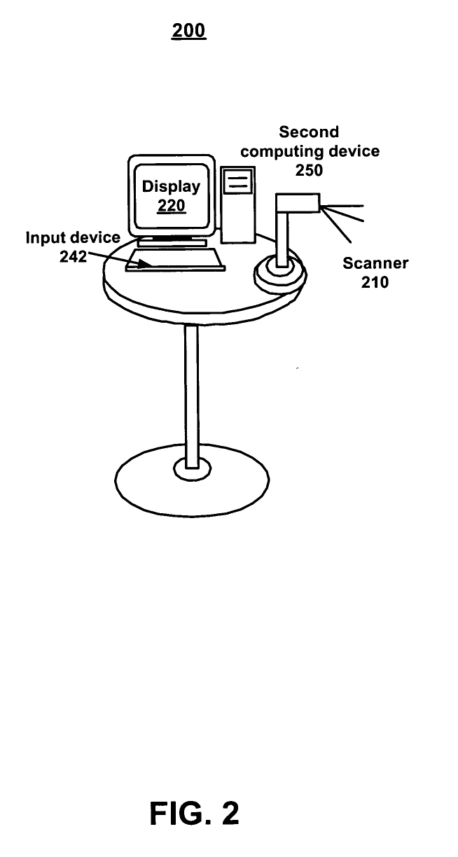

With reference still to FIG. 1, mobile personal identifier 120 is a communication device that may be used to receive information from a computing device 110 and supply information to a computing device 110 or scanning device 210 (of FIG. 2). In one embodiment, mobile personal identifier 120 will track itself throughout the store and report the information back to computing device 110. In another embodiment, the mobile personal identifier 120 may provide feedback to the computing device 110 while it is in motion, and in yet another embodiment, mobile personal identifier 120 will provide feedback to the computing device 110 after it is returned to the system 100. In one embodiment, mobile personal identifier 120 communicates via wireless communications protocols well known in the art.

With reference now to FIG. 2, a system for self-service scanning and purchasing is shown in accordance with one embodiment of the present invention. In general, second computing system 200 includes a scanner 210 and a display 220. In one embodiment, first computing device 110 and second computing device 250 are similar computing devices. For example, they have a processor, a bus, volatile and non-volatile memory, a display screen, and input and output wired and wireless capabilities. Scanner 210 of system 200 may be a laser-type scanning device that is used to read bar code or other scannable type data. The data (e.g., alphanumeric code) from the scanner is then input into second computing device 250 and the product specifications (e.g., price, size, manufacture, etc.) are recalled from a database. The information is then displayed on display 220. In one embodiment, additional information may also be displayed on display 220. For example, a coupon, competing product, cheaper product, or related product may be displayed to the customer. Furthermore, although the second computing device 250 is shown on a stand, the stand is optional. In other embodiments the stand may not exist, may be a desk, may be a wall mount, may be a table, or the like.

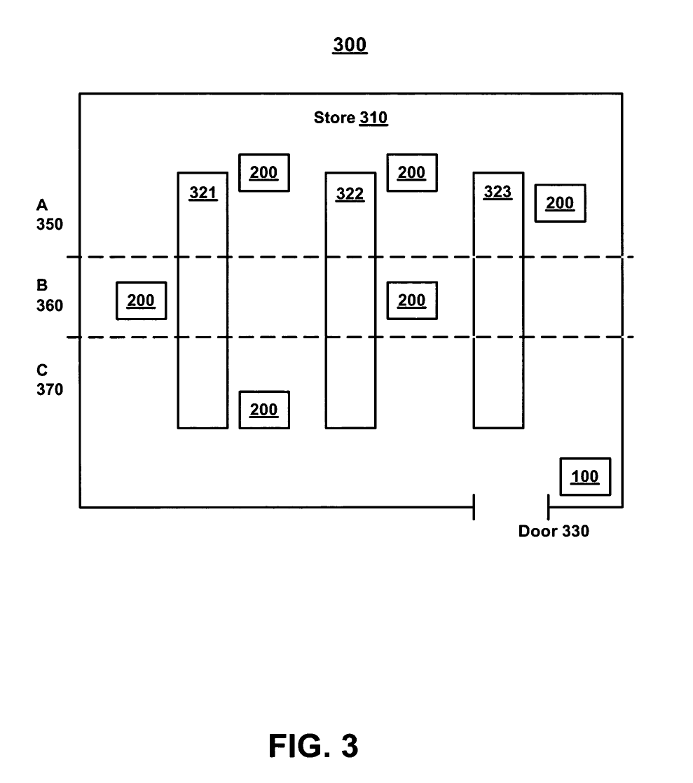

With reference now to FIG. 3, a diagram of an exemplary store configuration for self-service shopping is shown in accordance with one embodiment of the present invention. Configuration 300 of store 310 is one embodiment of a possible plurality of store 310 layouts. The exemplary layout of store 310 is meant to provide clarity to the basic operation of the self-service shopping apparatus. It is not the way for laying out a store 310, but it is one way for laying out a store 310. It is noted that there may be more or fewer of each of the components in the store 310. Each number of components is randomly selected and illustrates only one of an infinite amount of possible store 310 configurations.

Referring still to FIG. 3, the store configuration 310 includes a first computing system kiosk 100 (e.g., computing device 110, display 130, input device 140 and 142, mobile personal identifier 120, and the like), a plurality of second computing system kiosks 200 (having, computing device 250, display 220, scanner 210, input device 242, and the like) and a layout of a three aisle (e.g., 321, 322, and 323) store 310. Additionally, the store is broken into three sections, section A 350, section B 360, and section C 370.

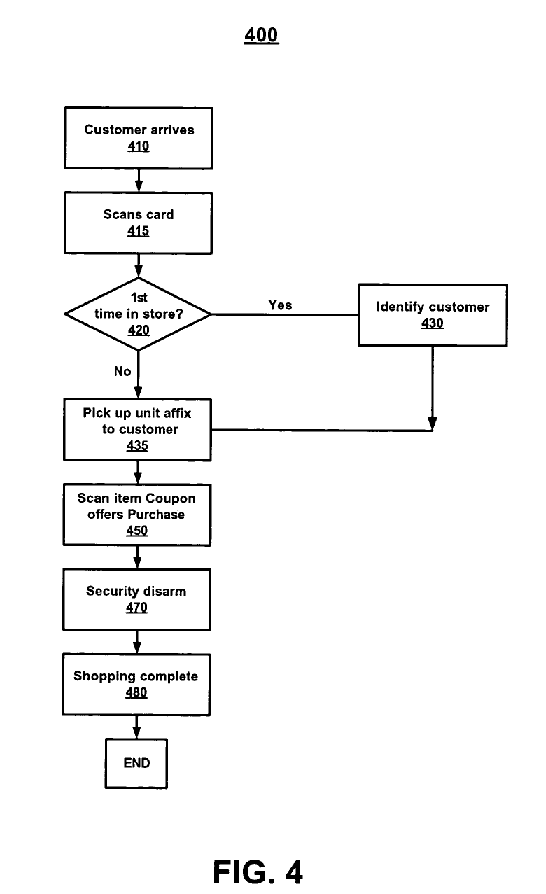

With reference now to FIG. 4, a flowchart for self-service shopping is shown in accordance with one embodiment of the present invention. Flowchart 400 is one exemplary self-service shopping experience. In other embodiments any or all of the steps in flowchart 400 may or may not occur. The use of flowchart 400 in the present embodiment is for purposes of clarity.

Referring now to step 410 of FIG. 4 and to FIG. 3, in one embodiment a customer arrives at store 310. The customer enters the store through door 330 and proceeds to computing device kiosk 100 to check in and receive the mobile personal identifier. In another embodiment, the customer may skip the check in at computing device kiosk 100 and begin shopping. Then, when the customer is ready to check out, the customer may utilize any one of the second computing system kiosks 200 and input the user information there. The customer then checks out, bags any purchased products, and departs the store. However, if the customer does check in, then in one embodiment, the following steps are performed.

With reference now to step 415 of FIG. 4 and to FIG. 3, in one embodiment the customer swipes a card (e.g., credit card, debit card, driver's license, store customer card, or the like) to register his/her identity with the system 100. In another embodiment, a customer may type into the input keyboard 142 to register his/her identity with the system 100. In yet another embodiment, a biometric (e.g., retina scan, fingerprint, Breathalyzer, DNA sample, or the like) may be used to register his/her identity with the system 100.

Referring now to step 420 of FIG. 4 and to FIG. 3, in one embodiment the first computing device 110 checks the database to find out whether the user is a new customer or a returning customer.

With reference now to step 430 of FIG. 4 and to FIG. 3, in one embodiment if the customer is a new customer then the customer identifies him/herself to the computing device 110. For example, a few questions may be asked of the user to design a profile for the user. In one embodiment, the profile may be used to direct advertisement to the customer, to suggest items, and/or to direct the customer to the proper location in the store. For example, if the customer is a professional painter then the computing device 110 may show the customer the paint specials for large orders, or provide a map of the store showing the location of the painting products. In another embodiment, the customer selects no profile and the computing device 110 will store only the customer's payment information in the mobile personal identifier 120. In yet another embodiment, the mobile personal identifier 120 incorporates a small display screen that is used to show a map with a constant dot indicating “you are here” and a blinking dot indicating the location of the item. There may be a plurality of display methods including the constant dot indicating the product location, two blinking dots, different colors, different shapes, different colors and shapes, alphanumeric presentations, symbols, and the like. Additionally, the map may be rudimentary or detailed and may zoom in or out, show real time tracking updates, and the like.

With reference now to step 435 of FIG. 4 and to FIG. 3, in one embodiment once the customer identifies him/herself or is recognized as a previous customer, an mobile personal identifier 120 will be issued to the customer. The mobile personal identifier 120 receives the user profile from the computing device 110 and maintains the information until it is reset. In another embodiment, the mobile personal identifier 120 maintains the user profile 120 until the user returns the mobile personal identifier 120 to the computing device 110 and any data in the mobile personal identifier 120 is downloaded to the computing device 110.

In one embodiment, the mobile personal identifier 120 also has a transmitter that identifies the customer to system sensors placed throughout the store. The mobile personal identifier 120 is mobile and may be clipped to clothing, affixed to the shopping cart or basket, put in the pocket, worn like jewelry, or the like. In one embodiment, the mobile personal identifier 120 utilizes wireless protocols (e.g., Bluetooth, or the like) to transmit and receive data from the first computing device 110 and the second computing system 200 and any other sensors placed throughout the store. In another embodiment, mobile personal identifier 120 is a USB device or smartcard, or the like, that is inserted, swiped, or passed near the second computing system 200.

In one embodiment, as a customer approaches the second computing system 200 (e.g., when mobile personal identifier 120 comes within 2-3 feet, or any user defined distance), the second computing system 200 senses the mobile personal identifier 120 and therefore identifies the customer. In one embodiment, the computing station may show any items already purchased and/or scanned and additionally may offer help, directions, similar product pricing, or the like.

With reference now to step 450 of FIG. 4 and to FIG. 3, in one embodiment the customer may use the scanner 210 of second computing system 200 to scan an item and may further use the second computing device 250 to price an item, buy an item, receive a coupon for the item, receive an offer of better value (size up-sell), receive an offer for a competing brand (promotion), and/or receive an offer for a quantity break (quantity up-sell). The display screen 220 may also display manufacturer-paid advertisements keyed to purchases the customer is making, products the customer is scanning, or products the customer profile matches.

The second computing device 250 may also identify product location for the customer down to the specific aisle, side, and shelf location alphabetically and graphically. For example, a customer may access alphabetical list by generic product type or by brand. In another embodiment, a smart search may be used thereby allowing the customer to find an item or items that has a different name than the customer inputs. In that case, the second computing device 250 may list a plurality of items of similar name, genre (e.g., soap, paint, etc.), and/or provide visual graphics of items for the user to select from. In one embodiment, once the customer selects the appropriate item, the second computing device 250 identifies the location of the item to include aisle, side, shelf, space, or the like. For example, with reference to FIG. 3, the customer may be directed to aisle 322, left side, section B 360. Additionally, this information may be printed out and provided to the customer.

In another embodiment, the mobile personal identifier 120 may receive the directions from the second computing devices(s) 250 and alert the user when they have reached the proper location for the product. For example, the mobile personal identifier 120 may vibrate, blink, sound-off, or the like to provide the customer feedback regarding the location of the item. In another embodiment, the mobile personal identifier 120 may signal the customer by increasing the activity (e.g., signal) as the customer gets closer and decreasing the activity as the customer move's further away. In yet another embodiment, having the mobile personal identifier 120 perform these functions may be optional.

By using the second computing system(s) 200 located throughout the store, the customer can locate goods more effectively and check himself or herself out more conveniently. Therefore, the shopping experience is enhanced for the customer. In addition, by utilizing the tracking information stored in the mobile personal identifier 210, the merchant can more efficiently collect customer data and utilize that data to optimize goods location for maximum profits. Moreover, due to the convenience and efficiency of the checking out process, a customer will be less inclined to rethink the impulse buy.

With reference now to step 470 of FIG. 4 and to FIG. 3, in one embodiment the security device on the product is disabled. For example, after a customer scans the product and purchases the product, the second computing system 200 may then demagnetize the product's security device (or perform another action if the security device is other than magnetic) allowing the customer to exit the store without alarm.

If a customer desires to return a product already purchased, the product may be “un-scanned” re-magnetized and returned to the shelf. In one embodiment, if the customer is scanning a plurality of items and has not yet paid for the items, an item may be “un-scanned” and returned to the shelf (or a designated return location) and the item will be removed from the database. Therefore, due to the networking between second computing system 200, the first computing system 100, and the mobile personal identifier 120, a customer may seamlessly navigate between aisles as shown in FIG. 3. Furthermore, the customer may utilize the plurality of second computing systems 200 without re-entering data including products scanned but not yet purchased, products scanned and purchased, and/or products not yet scanned.

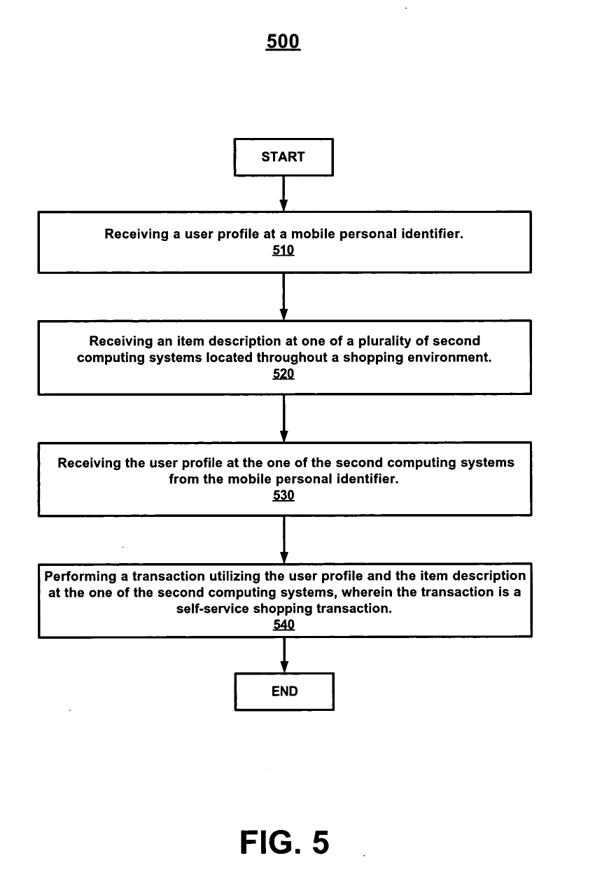

With reference now to FIG. 5, a flowchart for self-service shopping is shown in accordance to another embodiment of the present invention. In general, the steps of flowchart 500 begin after a customer has entered a store.

Referring now to step 510 of FIG. 5 and to FIG. 1, in one embodiment the user profile is received at a mobile personal identifier. In one embodiment, the mobile personal identifier 120 is a mobile device communicatively coupled with the first computing device 110. Therefore, the mobile personal identifier 120 may be carried on the person of the customer. That is, it may be pinned on, put in the pocket, worn like jewelry, clipped to the belt loop, tied to the shoe, affixed to the shopping cart or basket, or the like. In another embodiment, the mobile personal identifier may be a personal device such as a mobile phone, GPS receiver, or PDA, which is selected by the user to act as the mobile personal identifier while in the store. In one embodiment, the user profile is passed to the mobile personal identifier wirelessly.

As described herein, the user profile may be received after a user swipes a credit/debit card, performs a biometric task, enters alphanumeric information, or the like into the first computing device. In one embodiment, the first computing device 110 may include a visual display 130 and an input device (e.g., card reader 140 or keyboard 142) for registering a form of payment. In another embodiment, visual display 130 may also be a touch screen and therefore the input device.

In addition, in one embodiment, the mobile personal identifier 120 provides a wireless positioning signal to the first computing device 110 to provide tracking information about the mobile personal identifier 120. In another embodiment, the mobile personal identifier 120 tracks and records its position and travel throughout the store and downloads the data to the first computing device 110 when it is returned to its initial location.

With reference now to step 540 of FIG. 5 and to FIG. 3, in one embodiment, one of the plurality of second computing systems 200 receives the user profile from the mobile personal identifier 120. For example, when the mobile personal identifier 120 comes within a certain pre-selected distance of one of the second computing systems 200. The communication from the mobile personal identifier 120 will allow the second computing device 250 to access the network and display the customers current items (purchased, scanned not purchased, etc.) and any other type of customized status screen. This prevents the customer from having to re-identify at any of the second computing systems' 200 each time it is used.

In general, an item is scanned at a second computing system 200. The item may be scanned using barcode, magnetism, microchips, or the like. Additionally, the item may be scanned as a price check, for purchase, or to see if any coupons or product comparisons are in the database.

As shown in FIG. 3, there may be a plurality of second computing systems 200 located all over the store 310. In addition, each second computing system 200 is a kiosk which may have bags for sacking the items purchased, a security device disarmer for disarming any security devices attached to the item, and/or a printer for printing a receipt. In another embodiment, the receipt may be e-mailed as a part of the user profile and no printed receipt may be necessary.

With reference now to step 540 of FIG. 5 and to FIG. 3, in one embodiment, a transaction is performed utilizing the user profile and the item description at the one of the second computing devices, wherein the transaction is a self-service shopping transaction. That is, the item is purchased at the second computing system 200 without requiring further interaction with the second computing system 200. For example, the mobile personal identifier 120 has maintained and transferred the user profile to the second computing system 200 and therefore, the user need only select purchase and the correct account will be billed to the customer's preferred payment method. In another embodiment, if the customer did not check in at the first computing device 110 and has selected an item and has scanned it at the second computing system 200, then the purchase may be performed by inputting the purchasing data at the second computing system 200.

After the purchase is complete and the customer returns the mobile personal identifier 120 and departs the store, in one embodiment, the first computing device 110 will collect the tracking data from the mobile personal identifier 120 (or compile the tracking data if it was collected on the fly) and the scanning information from the second computing system 200 and store it in a database for evaluation.

Furthermore, as described in detail herein, at any point in the shopping experience, a customer may access either the first computing device 110 or the second computing device 250 and perform a search for a product and/or receive direction to a product. This may include searches of the product database by name, description, song, manufacturer, use, or the like.

Therefore, embodiments of the present invention provide a more convenient and efficient method for shopping and purchasing products. Additionally, embodiments of the present invention reduce the number of personnel required to operate a user-friendly store. Furthermore, embodiments of the present invention provide the option for stores to reclaim floor space formerly reserved for checkout counters and lines for use with other revenue-producing purposes. Additionally, stores can collect customer shopping data to include the time the customer arrives at the store, which entrance was used by virtue of first computing device accessed, the elapsed time between scans, the path the customer took throughout the store (from mobile personal identifier 120 or extrapolated from second computing device 250 visits), and /or total time shopped. This data may be used to remove the preferred customer mentality (e.g., carrying separate cards per store), and allow manufacturers to accurately deliver coupon access to customers who are price checking at actual time of purchase.

Embodiments of the present invention are thus described. While the present invention has been described in particular embodiments, it should be appreciated that the present invention should not be construed as limited by such embodiments, but rather construed according to the following claims.

1. A method for self-service shopping, said method comprising:
receiving a user profile at a mobile personal identifier;
receiving an item description at one of a plurality of second computing systems located throughout a shopping environment;
receiving said user profile at said one of said second computing systems from said mobile personal identifier; and
performing a transaction utilizing said user profile and said item description at said one of said second computing systems, wherein said transaction is a self-service shopping transaction.

2. The method of claim 1 wherein a first computing system communicates said user profile to said mobile personal identifier, said first computing system comprising:
a computing device;
a visual display;
an input device for receiving said user profile; and
a communications device for transmitting said user profile to said mobile personal identifier and receiving information from said mobile personal identifier.

3. The method of claim 1 wherein the second computing system communicates comprises:
a computing device;
a visual display;
an scanner for receiving said item description;
a communications device for receiving said user profile from said mobile personal identifier;
a printer for receipt; and
a cash-back device.

4. The method of claim 2 wherein said mobile personal identifier is issued by said first computing system, said first computing system comprising a plurality of said mobile personal identifiers.

5. The method of claim 2 wherein the mobile personal identifier provides a wireless positioning signal comprising tracking information to said first computing system.

6. The method of claim 5 wherein the first computing system collects the tracking information from the mobile personal identifier and the transaction information from the second computing system and stores it in a database.

7. The method of claim 2 wherein said first computing system and said second computing system further comprise:
performing a search for a product; and
providing direction to find said product.

8. The method of claim 7 wherein said mobile personal identifier stores the directions to find said product and provides a signal for directional assistance in finding said product.

9. A self-assisted shopping system comprising:
a first computing system configured to receive a user profile;
a mobile personal identifier communicatively coupleable with said first computing system, said mobile personal identifier configured to receive said user profile from said first computing system; and
a plurality of second computing systems placed throughout a shopping environment, said second computing systems configured to receive said user profile from said mobile personal identifier, said second computing systems adapted to use said user profile to perform a transaction.

10. The self-assisted shopping system of claim 9 wherein the first computing system comprises:
a computing device;
a visual display; and
an input device for receiving said user profile.

11. The self-assisted shopping system of claim 10 wherein said visual display is interactive.

12. The self-assisted shopping system of claim 9 wherein the mobile personal identifier provides location information to said first computing system throughout a shopping environment.

13. The self-assisted shopping system of claim 9 wherein the first computing system further comprises:
performing a search for a product; and
providing direction to the location of the product.

14. The self-assisted shopping system of claim 9 wherein said mobile personal identifier is issued by said first computing system.

15. The self-assisted shopping system of claim 9 wherein each of the plurality of second computing systems further comprise interactive visual displays.

16. The self-assisted shopping system of claim 15 wherein each of the second computing systems provides information about a competing product when a product is scanned.

17. A computer-usable medium having computer-readable program code embodied therein for causing a caching proxy to perform a method for self-service shopping, said method comprising:
receiving a user profile at a mobile personal identifier;
receiving an item description at one of a plurality of second computing systems arrayed throughout a shopping environment;
receiving said user profile at said one of said second computing systems from said mobile personal identifier; and
performing a transaction utilizing said user profile and said item description at said one of said second computing systems, wherein said transaction is a self-service shopping transaction.

18. The computer-usable medium of claim 17 wherein said mobile personal identifier is issued by said first computing system, said first computing system comprising a plurality of said mobile personal identifiers.

19. The computer-usable medium of claim 17 wherein the mobile personal identifier broadcasts a positioning signal to said first computing system, said positioning signal providing a tracking capability of said mobile personal identifier by said first computing system.

20. The computer-usable medium of claim 17 wherein said mobile personal identifier is issued by said first computing system, said first computing system comprising a plurality of said mobile personal identifiers

21. The computer-usable medium of claim 17 wherein said first computing system and said second computing system further comprise:
performing a search for a product; and
providing directions to find said product.
